(19) United States
(12) Patent Application Publication
(10) Pub. No.: US 2021/0387653 A1
(43) Pub. Date: Dec. 16, 2021

(54) RECONSTRUCTION METHOD FOR SECURE ENVIRONMENT ENVELOPE OF SMART VEHICLE BASED ON DRIVING BEHAVIOR OF VEHICLE IN FRONT

(71) Applicant: JIANGSU UNIVERSITY, Zhenjiang (CN)

(72) Inventors: Youguo HE, Zhenjiang (CN); Chaochun YUAN, Zhenjiang (CN); Long CHEN, Zhenjiang (CN); Haobin JIANG, Zhenjiang (CN); Yingfeng CAI, Zhenjiang (CN); Hai WANG, Zhenjiang (CN)

(21) Appl. No.: 16/342,980

(22) PCT Filed: Mar. 29, 2017
(86) PCT No.: PCT/CN2017/078516

§ 371 Date: Apr. 18, 2019

(30) Foreign Application Priority Data
Oct. 19, 2016 (CN) 201610910341.1

(51) Int. Cl. B60W 60/00; B60W 30/095; G06N 7/00

(52) U.S. Cl. CPC B60W 60/00274; B60W 30/0953; B60W 30/0956; B60W 2554/801; B60W 2554/804; B60W 2754/30; G06N 7/005

(57) ABSTRACT

A reconstruction method for a secure environment envelope of a smart vehicle based on the driving behavior of a vehicle in front, starting from the simulation of the behavior of a real driver pre-estimating the potential collision risk of the drive area in front, introducing a prediction regarding the driving behavior of the vehicle in front to the environment sensing link of the smart vehicle, reconstructing, on the basis of the prediction result regarding the driving behavior of the vehicle in front, a secure environment envelope of the smart vehicle. The method uses a signal as an observed value, such as the trajectory point sequence of the vehicle in front, the indicators of the vehicle in front, the smart vehicle speed, the relative longitudinal speed of the smart vehicle and the vehicle in front, etc., and predicts the driving behavior of the vehicle in front by means of a hidden markov model (HMM); the method corrects, on the basis of the prediction result about the driving behavior of the vehicle in front, the transverse spacing and the longitudinal spacing between the smart vehicle and the vehicle in front, realizes the reconstruction of a secure environment envelope of a smart vehicle, and further realizes the pre-estimation regarding the potential collision risk of the smart vehicle in the safe drive area, and improves the security of the smart vehicle.

### TECHNICAL FIELD

The invention relates to the field of intelligent vehicle, in particular to a reconstruction method of intelligent vehicle sat environment envelope based on forward vehicle driving behavior.

### BACKGROUND TECHNOLOGY

With the rapid development of automobile industry and the continuous improvement of people's living standards, the car ownership continues to climb, followed by a series of urgent problems such as increasing traffic pressure, road congestion, frequent traffic accidents and so on. As an effective way to solve the above problems, intelligent transportation system has attracted wide attention from all walks of life. As a new technology in intelligent transportation system, intelligent vehicle has become a research hotspot at home and abroad. The first problem to be solved in intelligent vehicles is environmental perception, which is to perceive the traffic environment around vehicles and the motion parameters of intelligent vehicles through visual sensors, radar sensors vehicle sensors and so on. It can be found that domestic and foreign scholars have only perceived the current motion parameters of surrounding vehicles of intelligent vehicle, and carry out path planning and tracking control nowadays. However, the random change of driving behavior of surrounding vehicles, especially forward vehicles, makes it difficult for intelligent vehicles to predict the potential collision risk, thus affecting the accuracy of path planning and tracking control. Therefore, in order to simulate the behavior of predicting potential collision risk during human driving, the forward vehicle driving behavior prediction is introduced into the safety environment envelope. According to the forward vehicle driving behavior, the safety environment envelope is reconstructed, and the potential collision risk is predicted, so as to improve the safety of intelligent vehicles.

Therefore, the invention proposes a reconstruction method of intelligent vehicle safety environment envelope based on forward vehicle driving behavior, which senses the traffic environment and forward vehicle of intelligent vehicle through camera and lidar, establishes a prediction model of forward vehicle driving behavior, and predicts forward vehicle driving behavior. According to the forecasting results of driving behavior of forward vehicles, the lateral and longitudinal spacing between intelligent vehicles and forward vehicles are modified to reconstruct the safety environment envelope of intelligent vehicles, and then the potential collision risk is estimated to improve the safety of intelligent vehicles. By consulting the data, the application of introducing forward driving behavior into safety environment envelope of intelligent vehicles has not been reported yet.

### CONTENTS OF THE INVENTION

The aim of the invention is to provide a reconstruction method of intelligent vehicle safety environment envelope based on forward vehicle driving behavior. Starting from simulating the real drivers behavior of predicting the potential collision risk in the forward driving area, the prediction of forward driving behavior is introduced into the environmental perception of intelligent vehicles. Based on the prediction results of forward driving behavior, the safety environment envelope of intelligent vehicles is reconstructed. The method takes the signals of forward vehicle trajectory point sequence, forward vehicle steeling lights, intelligent vehicle speed, longitudinal relative speed of intelligent vehicle and forward vehicle as observation values, predicts driving behavior of forward vehicle by Hidden Markov Model (HMM). According to the forecasting results of driving behavior of forward vehicles, the lateral and longitudinal spacing between intelligent vehicles and forward vehicles are modified to reconstruct the safety environment envelope of intelligent vehicles, and then the potential collision risk is estimated which improve the safety of intelligent vehicles.

The technical scheme of the invention: A reconstruction method of intelligent vehicle safety environment envelope based on forward vehicle driving behavior is composed of forward vehicle driving behavior prediction model and intelligent vehicle safety environment envelope reconstruction algorithm. Forward vehicle driving behavior prediction model is responsible for the prediction of forward vehicle driving behavior, and intelligent vehicle safety environment envelope reconstruction algorithm is responsible for the reconstruction of safety environment envelope based on the prediction results.

The forward vehicle driving behavior prediction model described in the invention is as follows:

Based on HMM theory, HMM prediction model λ=(N, M, π, A, B) for forward vehicle driving behavior is established, which including:

The driving behavior states of forward vehicle is S: S=(S₁, S₂, . . . S_{N}), the state at a given time t is qₜ, and qₜ∈S; status number of the invention N=4 , where S₁ is represent for uniform driving behavior; S₂ is the emergency braking driving behavior; is the driving behavior an steering left; S₄ is the driving behavior on steering right.

The observation sequence is V: V=(v₁, v₂, . . . v_{M}); observing events Oₜ is at a given time t. The observations number of the invention: M=7; where v₁ is the observation value of polar diameter changing of adjacent trajectory point sequences of forward vehicle; v₂ is the observation value of the pole angle changing of the sequence of adjacent trajectory point sequences of forward vehicle; v₃ is intelligent vehicle speed; v₄ is the longitudinal relative speed of the intelligent vehicle and the forward vehicle; v₅ is the turn signal to the left of the forward vehicle; v₆ is the turn signal to the right of the forward vehicle; v₇ is the brake signal of the forward vehicle.

π is the probability vector of initial state of forward vehicle driving behavior; π=(π₁, π₂, . . . π_{N}), where πᵢ=P(q₁=Sᵢ).

A is the state transition matrix, that is, state transition matrix of forward vehicle driving behavior; A={aᵢⱼ}_{N×N}, where aᵢⱼ=P(qₜ₊₁=Sⱼ|qₜ=Sᵢ), 1≤i, j≤N.

B is the probability distribution matrix of observed events; namely, probability of generating observation vₖ at state Sⱼ: B={bⱼₖ}_{N×M} where bⱼₖ=P[Oₜ=vₖ|qₜ=Sⱼ], 1≤j≤N, 1≤k≤M.

Intelligent vehicle safety environment envelope reconstruction algorithm:

The secure driving area in front of the intelligent vehicle is determined based on the lateral and longitudinal distance between the forward vehicle and the intelligent vehicle, that is, the safety environment envelope is descried in this invention. According to the sensor and dynamic model, the relative position information of the intelligent vehicle and the forward vehicle is established, as shown in formula (1):

$$[ \begin{matrix}Δ {p}_{x , j} ( t ) \\ Δ {p}_{y , j} ( t )\end{matrix} ] = [ \begin{matrix}cos ( - {e}_{ψ} ( t ) ) & - sin ( - {e}_{ψ} ( t ) ) \\ sin ( - {e}_{ψ} ( t ) ) & cos ( - {e}_{ψ} ( t ) )\end{matrix} ] [ \begin{matrix}{p}_{x , j} ( t ) - {p}_{x , sub} ( t ) \\ {p}_{y , j} ( t ) - {p}_{y , sub} ( t )\end{matrix} ] \qquad ( 1 )$$

Where p_{x,j}(t) is the longitudinal coordinates of the jth forward vehicle; p_{x,sub}(t) is the longtudinal coordinates of the intelligent vehicle; e_{Ψ}(t) is the position error between vehicle and road surface; p_{y,j}(t) is the lateral coordinates of the jth forward vehicle; p_{y,sub}(t) is the lateral coordinates of the intelligent vehicle; Δp_{x,j}(t) is the longitudinal relative distance between the smart vehicle and the jth forward vehicle; Δp_{y,j}(t) is the lateral relative distance between the smart vehicle and the jth for and vehicle.

The distance between intelligent vehicle and forward vehicle can be obtained by transformation, as shown in equation (2):

$$[ \begin{matrix}{C}_{x , j} ( t ) \\ {C}_{y , j} ( t )\end{matrix} ] = [ \begin{matrix}Δ {p}_{x , j} ( t ) \\ Δ {p}_{y , j} ( t )\end{matrix} ] - [ \begin{matrix}sgn ( Δ {p}_{x , j} ( t ) ) \cdot {L}_{v} \\ sgn ( Δ {p}_{y , j} ( t ) ) {W}_{v}\end{matrix} ] \qquad ( 2 )$$

Where: Lᵥ length of the forward vehicle; Wᵥ is the width of the forward vehicle; C_{x,j}(t) is longitudinal distance between intelligent vehicle and forward vehicle; C_{y,j}(t) is the lateral distance between intelligent vehicle and forward vehicle.

The longitudinal and lateral distance between the intelligent vehicle and the forward vehicle expressed in equation (2) is calculated based on the current position of the forward vehicle, which is regarded as the reference of the safety environment envelope of the intelligent vehicle at a given next time, and the randomicity of driving behavior changes of the forward vehicle is not considered. The lateral distance between the intelligent vehicle and forward vehicle will increase or decease at the next moment, when the forward vehicle has left-turn driving behavior or right-turn driving behavior. The longitudinal distance between the intelligent vehicle and forward vehicle will decrease, when the intelligent vehicle has emergency braking driving behavior at the next moment. Therefore, to estimate the potential collision risk of driving area, this invention will propose that driving behavior prediction of forward vehicle is introduced into the reconstruction links for safety environment envelope of intelligent vehicle. Based on the predicted results, the longitudinal and lateral distance between the intelligent vehicle and the forward vehicle are modified to realize the reconstruction for safety environment envelope of intelligent vehicle. Modifier formulas (3) are shown as below:

$$[ \begin{matrix}{C}_{x , j}^{′} ( t ) \\ {C}_{y , j}^{′} ( t )\end{matrix} ] = [ \begin{matrix}{ω}_{x} & 0 \\ 0 & {ω}_{y}\end{matrix} ] \cdot [ \begin{matrix}{C}_{x , j} ( t ) \\ {C}_{y , j} ( t )\end{matrix} ] \qquad ( 3 )$$

Where parameter ωₓ is the longitudinal correction factor, and represents the variations in scale of longitudinal distance, the value range of ωₓ is between 0 and 1 on account of the longitudinal prediction result of forward vehicle based on uniform driving behavior or emergency braking driving behavior. Parameter ω_{y} is the lateral correction factor and represents the variations in scale of lateral distance. Considering the lateral relative position of the intelligent vehicle and the forward vehicle, the value range of ω_{y} is between 0 and 1 on account of the lateral prediction result of forward vehicle based on left-turn or right-turn driving behavior when the lateral spacing gets smaller. While the lateral distance gets larger, the value of it is greater than 1. To improve the accuracy of envelope reconstruction for secure environment of intelligent vehicle, the probability value of the result predicted by HMM model is applied to determine the value of ωₓ and ω_{y}.

### ADVANTAGES OF THE INVENTION

Starting from simulating an actual driver's estimation of potential collision risks in the forward driving area, the forward vehicle driving behavior prediction is introduced to the environment perception link of the intelligent vehicle and sudden braking or sudden steering behavior of forward vehicle during driving is predicted. The safety environment envelope is reconstructed according to the driving behavior of forward vehicle, and the potential collision risk in the driving area is estimated, thus improving the safety of intelligent vehicles.

### DESCRIPTION OF THE DRAWINGS

FIG. 1 is the system block diagram of the invention.

FIG. 2 is the off-line training flow chart of the forward vehicle driving behavior prediction model.

FIG. 3 is the predicting flow chart of driving behavior of the forward vehicle.

FIG. 4 is a schematic diagram of the variation of lateral spacing when the forward vehicle has left-turn driving behavior.

Where, figure (a) shows the current lateral distance between the intelligent vehicle and the forward vehicle, and figure (b) shows the lateral distance between the intelligent vehicle and the forward vehicle when the forward vehicle has left-turn driving behavior.

FIG. 5 is a schematic diagram of longitudinal spacing varying when the forward vehicle has emergency braking driving behavior.

Where, figure (a) shows the current longitudinal distance between intelligent the vehicle and the forward vehicle, figure (b) shows the longitudinal distance between the intelligent vehicle and the forward vehicle when the forward vehicle has emergency braking driving behavior.

Parameters in the figures: \textcircled{1}: intelligent vehicle; \textcircled{2}: the forward vehicle; C_{x,j}(t): the longitudinal distance between intelligent vehicle and forward vehicle; C′_{x,j}(t): the reconstructed longitudinal distance between intelligent vehicle and forward vehicle considering driving behavior of forward vehicle; C_{y,j}(t): the lateral distance between intelligent vehicle and forward vehicle: C′_{y,j}(t): the reconstructed lateral distance between intelligent vehicle and forward vehicle considering driving behavior of forward vehicle.

### SPECIFIC IMPLEMENTATIONS

Following is a clear and complete description of the concept and specific working process of the invention with reference to the drawings and examples. Obviously, the described embodiments are only part of the embodiments of the present invention, not all of them. Based on the embodiments of the present invention, other embodiments acquired by skilled personnel in the field without any creative effort belong to the scope of protection of the present invention.

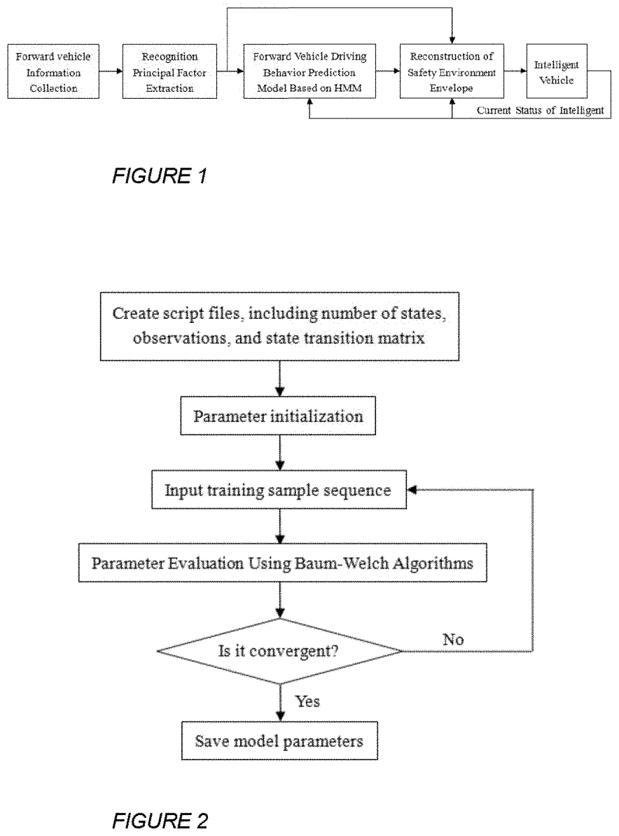

As shown in FIG. 1, a reconstruction method of intelligent vehicle safely environment envelope based on forward vehicle driving behavior is composed of forward vehicle driving behavior prediction model and intelligent vehicle safety environment envelope reconstruction algorithm. 1. The realization process of the forward vehicle driving behavior prediction model is as follows:

Establishment of forward vehicle driving behavior prediction model: The driving behavior prediction model established for forward vehicle including: Uniform driving behavior prediction model (US_HMM), Emergency brake driving behavior prediction model (EB_HMM), Left-turn driving behavior prediction model (LT_HMM) and Right turn driving behavior prediction model (RT_HMM).

Off-line training of forward vehicle driving behavior prediction model: As shown in FIG. 2, the off-line training flow chart of the invention includes the following steps:

(1) Model parameter initialization, mainly initialize parameters of HMM model, such as π, A, and B.

(2) The forward-backward algorithm is selected to calculate the forward frequency αₜ(i) and backward probability βₜ(j) with the current sample.

(3) Baum-Welch algorithm was applied to calculate the estimated value \hat{λ}=(π, A, B) of the current new model.

(4) Calculate the likelihood probability P=(O/\hat{λ}).

(5) If P=(O/\hat{λ}) is increasing continually the next time, the new estimated value calculated by step (3) will be re-estimated for the sample, and returned to step (2), it is iterated step by step until P=(O/\hat{λ})is no longer significantly increased, i.e., converges. At this time, the model \hat{λ} is the model in requirement.

The training process of the present invention is illustrated by an example of a left-turn driving behavior prediction model (LT_HMM).

### (1) Selection of Training Samples

For left-turn driving behavior prediction model, the invention will consider observed sequence including seven parameters: the observed value of the pole diameter changes of the forward vehicle adjacent trajectory points sequence, the pole angle changes of the forward vehicle adjacent trajectory points sequence, intelligent vehicle speed, longitudinal relative velocity between intelligent vehicle and the forward vehicle, left turn signal, right turn signal, and brake lamp of the forward vehicle respectively. The observation sequence is described as a vector, as shown in equation (4).

O(f)={v₁ v₂ v₃ v₄ v₅ v₆ v₇} (4)

Where v₁ is the observed value of the pole diameter changes of the forward vehicle adjacent trajectory points sequence, v₂ is the observed value of pole angle changes of the forward vehicle adjacent trajectory points sequence; v₃ is the observed value of intelligent vehicle speed; v₄ is the observed valve of longitudinal relative velocity between intelligent vehicle and the forward vehicle; v₅, v₆, v₇ is left turn signal, right turn signal, and brake lamp of the forward vehicle respectively. Note: The number of samples is 100.

### (2) Model Parameter Initialization

The invention adopts the mean value method to obtain initial value of π, and A:

$$π = [ 0.25 \; 0.25 \; 0.25 \; 0.25 ] , A = [ \begin{matrix}0.25 & 0.25 & 0.25 & 0.25 \\ 0.25 & 0.25 & 0.25 & 0.25 \\ 0.25 & 0.25 & 0.25 & 0.25 \\ 0.25 & 0.25 & 0.25 & 0.25\end{matrix} ] .$$

The invention determines the initial probability distribution of the output probability matrix B based an the prior characteristics of different trajectory patterns:

$$B = [ \begin{matrix}0.2 & 0.2 & 0.1 & 0.2 & 0.1 & 0.1 & 0.1 \\ 0.3 & 0.08 & 0.08 & 0.08 & 0.08 & 0.08 & 0.3 \\ 0.08 & 0.3 & 0.08 & 0.08 & 0.3 & 0.08 & 0.08 \\ 0.08 & 0.3 & 0.08 & 0.08 & 0.08 & 0.3 & 0.08\end{matrix} ] .$$

### (3) Training Left-Turn Driving Behavior Prediction Model

According, to the off-line training process shown in FIG. 2 the left-turn driving behavior training samples are fed into the initial left-turn driving behavior prediction model for training, and finally the left-turn driving behavior prediction model is obtained.

$$\hat{π} = [ 0.0246 \; 0.0324 \; 0.1257 \; 0.8173 ] \text{;}$$

$$\hat{A} = [ \begin{matrix}0.1132 & 0.1271 & 0.2119 & 0.5478 \\ 0.0243 & 0.3471 & 0.2694 & 0.3592 \\ 0.1432 & 0.0221 & 0.5034 & 0.3213 \\ 0.4318 & 0.1349 & 0.2392 & 0.1941\end{matrix} ] \text{;}$$

$$\hat{B} = [ \begin{matrix}0.1912 & 0.2136 & 0.0981 & 0.952 & 0.1104 & 0.0896 & 0.1019 \\ 0.2851 & 0.0745 & 0.0847 & 0.0832 & 0.0791 & 0.0785 & 0.3149 \\ 0.0785 & 0.2832 & 0.0788 & 0.0847 & 0.3168 & 0.0791 & 0.0789 \\ 0.0791 & 0.2841 & 0.0831 & 0.0789 & 0.0806 & 0.3159 & 0.0783\end{matrix} ]$$

### 2. Prediction Process of Driving Behavior of Forward Vehicle

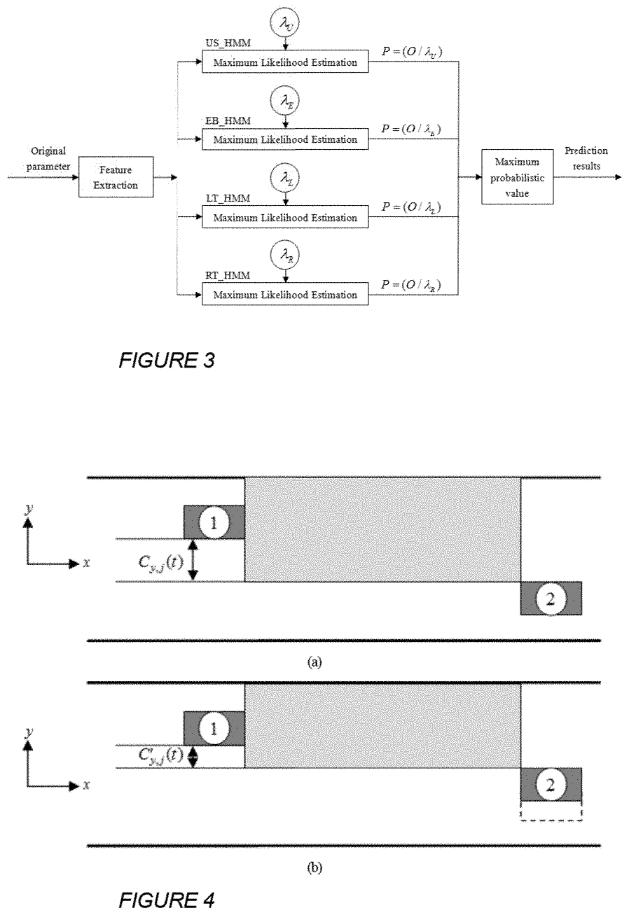

The prediction process is shown in FIG. 3. The original parameters are extracted to form a set of observation sequences O. The forward-backward algorithm is applied to calculate the probability P(O/λ) of each model generating the current observation sequence, and the driving behavior corresponding to model with the largest probability is the predicted result of driving behavior of forward vehicle.

### 3. Reconstruction of Safety Environment Envelope Based on Forward Vehicle Driving Behavior Prediction

The prediction result is considered on left-turning driving behavior of forward vehicle as an example to illustrate the lateral safe distance reconstruction method of the invention:

As shown in FIG. 4, when considering only the current position of forward vehicle \textcircled{2}, the lateral distance C_{y,j}(t) between intelligent vehicle \textcircled{1} and or and vehicle \textcircled{2} is shown as in FIG. 4(a). When considering that forward vehicle \textcircled{2} has left-turn driving behavior, the lateral distance C′_{y,j}(t) between intelligent vehicle \textcircled{1} and forward vehicle \textcircled{2} is show as FIG. 4(b). Comparing FIG. 4(a) and FIG. 4(b), we can see that the lateral spacing between the intelligent vehicle \textcircled{1} and the forward vehicle \textcircled{2} gets smaller. Based on the prediction result, lateral safety distance is reconstructed to achieve new lateral secure model C′_{y,j}(t)=ω_{y}C_{y,j}(t) , where ω_{y} is lateral correction factor, represents the variations in scale of lateral distance, and its value depend on the predicted maximum likelihood probability of the left-turning driving behavior of the forward vehicle driving behavior prediction model. It can be seen that when considering the left-turn driving behavior of vehicles in front, intelligent vehicles predict the left-turn driving behavior of forward vehicle, and reduce the risk of lateral collision by reconstructing the lateral safe distance.

The prediction result is considered on emergency braking driving behavior of forward vehicle as an example to illustrate the longitudinal safe distance reconstruction method of the invention:

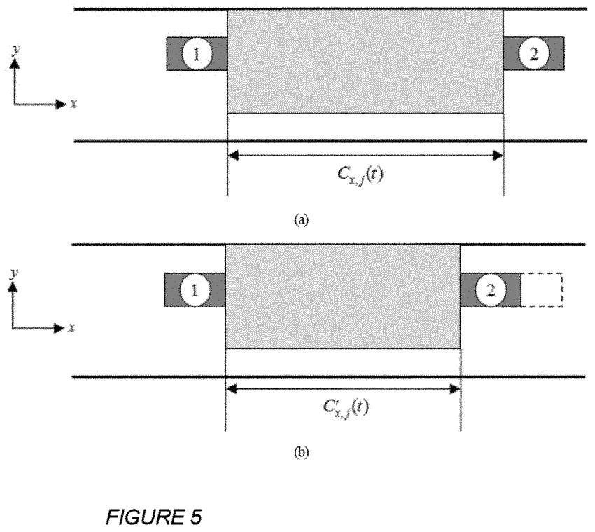

As shown in FIG. 5, when considering only the current position of forward vehicle \textcircled{2}, the longitudinal distance C_{x,j}(t) between intelligent vehicle \textcircled{1} and forward vehicle \textcircled{2} is shown as in FIG. 5(a). When considering that forward vehicle \textcircled{2} has emergency braking driving behavior, the longitudinal distance C′_{x,j}(t) between intelligent vehicle \textcircled{1} and forward vehicle \textcircled{2} is shown as FIG. 5(b). Comparing FIG. 5(a) and FIG. 5(b), we can see that the longitudinal spacing between the intelligent vehicle \textcircled{1} and the forward vehicle \textcircled{2} gets smaller. Based on the prediction result, longitudinal safe distance is reconstructed to achieve new longitudinal safe model C′_{x,j}(t)=ωₓC_{x,j}(t), where ωₓ is longitudinal correction factor, represents the variations in scale of longitudinal distance, and its value depend on the predicted maximum likelihood probability of the emergency braking driving behavior of the forward vehicle driving behavior prediction model. It can be seen that when considering the emergency braking driving behavior of forward vehicle, intelligent vehicle predict the emergency braking driving behavior of forward vehicle, and reduce the risk of longitudinal collision by, reconstructing the longitudinal safe distance.

The series of detailed explanations listed above are only specific explanations of the feasible embodiments of the invention, and they are not intended to limit the scope of protection of the invention. Any equivalent implementation or modification without departing from the spirit of the present invention shall be included in the scope of protection of the present invention.

1. A reconstruction method of intelligent vehicle safety environment envelope based on forward vehicle driving behavior, comprising forward vehicle driving behavior prediction model and intelligent vehicle safety environment envelope reconstruction algorithm, forward vehicle driving behavior prediction model is responsible for the prediction of forward vehicle driving behavior, and intelligent vehicle safety environment envelope reconstruction algorithm is responsible for the reconstruction of safety environment envelope based on the prediction results.

2. According to the reconstruction method of intelligent vehicle safety environment envelope based on forward vehicle driving behavior described in claim 1, the invention is characterized in that the forward vehicle driving behavior prediction model described in the invention is a HMM prediction model λ=(N, M, π, A, B), which including.
the driving behavior states of forward vehicle is S: S=(S₁, S₂, . . . S_{N}), the state at a given time t is qₜ, and qₜ∈S; status number of the invention N=4 where S₁ is represent for uniform driving behavior; S₂ is the emergency braking driving behavior; S₃ is the driving behavior on steering left; S₄ is the driving behavior on steering right;
the observation sequence is V: V=(v₁, v₂, . . . v_{M}); observing events is Oₜ at a given time t, the observations number of the invention: M=7 where v₁ is the observation value of polar diameter changing of adjacent trajectory point sequences of forward vehicle; v₂ is the observation value of the polar angle changing of the sequence of adjacent trajectory point sequences of forward vehicle; v₃ is intelligent vehicle speed: v₄ is the longitudinal relative speed of the intelligent vehicle and the forward vehicle; v₅ is the turn signal to the left of the forward vehicle; v₆ is the turn signal to the right of the forward vehicle; v₇ is the brake signal of the forward vehicle;
π is the probability vector of initial state of forward vehicle driving behavior; π=(π₁, π₂, . . . π_{N}), where πᵢ=P(q₁=Sᵢ);
A is the state transition matrix, that is, state transition matrix of forward vehicle driving behavior; A={aᵢⱼ}_{N×N}, where aᵢⱼ=P(qₜ₊₁=Sⱼ|qₜSᵢ), 1≤i, j≤N;
B is the probability distribution matrix of observed events; namely, probability of generating observation vₖ at state Sⱼ: B={bⱼₖ}_{N×M}, where bⱼₖ=P[Oₜ=vₖ|qₜ=Sⱼ], 1≤j≤N, 1≤k≤M.

3. According to the reconstruction method of intelligent vehicle safety environment envelope based on forward vehicle driving behavior described in claim 2, the invention is characterized in that forward vehicle driving behavior prediction model is implemented as follows:
establishment of forward vehicle driving behavior prediction model: the driving behavior prediction model established for forward vehicle including: uniform driving behavior prediction model (US_HMM), emergency brake driving behavior prediction model (EB_HMM), left-turn driving behavior prediction model (LT_HMM) and Right turn driving behavior prediction model (RT_HMM);
off-line training of four forward vehicle driving behavior prediction models;
prediction of forward vehicle driving behavior based on four forward vehicle driving behavior prediction models.

4. According to the reconstruction method of intelligent vehicle safety environment envelope based on forward vehicle driving behavior described in claim 3, the invention is characterized in that the off-line training process of the forward vehicle driving behavior prediction model includes:
(1) model parameter initialization, mainly initialize parameters of HMM model, such as π, A, and B;
(2) the forward-backward algorithm is selected to calculate the forward frequency αₜ(i) and backward probability βₜ(j) with the current sample;
(3) baum-Welch algorithm was applied to calculate estimated value \hat{λ}=(90 , A, B) of the current new model;
(4) calculate the likelihood probability P=(O/\hat{λ});
(5) P=(O/\hat{λ}) is increasing continually, the next time, the new estimated value calculated by step (3) will be re-estimated for the sample, and returned to step (2), it is iterated step by step until P=(O/\hat{λ}) is no longer significantly increased i.e., converges, at this time, the model \hat{λ} is the model in requirement.

5. According to the reconstruction method of intelligent vehicle safety environment envelope based on forward vehicle driving behavior described in claim 3, the invention is characterized in that Forward vehicle driving behavior prediction process includes:
the original parameters are extracted to form a set of observation sequences O; the forward-backward algorithm is applied to calculate the probability P(O/λ) of each model generating the current observation sequence, and the driving behavior corresponding to model with the largest probability is the predicted result of driving behavior of forward vehicle.

6. According to the reconstruction method of intelligent vehicle safety environment envelope based on forward vehicle driving behavior described in claim 1, the invention is characterized in that the intelligent vehicle safety environment envelope reconstruction algorithm is as follows:
according to the sensor and dynamic model, the relative position information of the intelligent vehicle and the forward vehicle is established, as shown below:
$$[ \begin{matrix}Δ {p}_{x , j} ( t ) \\ Δ {p}_{y , j} ( t )\end{matrix} ] = [ \begin{matrix}cos ( - {e}_{ψ} ( t ) ) & - sin ( - {e}_{ψ} ( t ) ) \\ sin ( - {e}_{ψ} ( t ) ) & cos ( - {e}_{ψ} ( t ) )\end{matrix} ] [ \begin{matrix}{p}_{x , j} ( t ) - {p}_{x , sub} ( t ) \\ {p}_{y , j} ( t ) - {p}_{y , sub} ( t )\end{matrix} ]$$
where p_{x,j}(t) is the longitudinal coordinates of the jth forward vehicle; p_{x,sub}(t) is the longitudinal coordinates of the intelligent vehicle: e_{Ψ}(t) is the position error between vehicle and road surface; p_{y,j}(t) is the lateral coordinates of the jth forward vehicle; p_{y,sub}(t) is the lateral coordinates of the intelligent vehicle: Δp_{x,j}(t) is the longitudinal relative distance between the smart vehicle and the jth forward vehicle; Δp_{y,j}(t) is the lateral relative distance between the smart vehicle and the jth forward vehicle:
the distance between intelligent vehicle and forward vehicle can be obtained by transformation, as shown below:
$$[ \begin{matrix}{C}_{x , j} ( t ) \\ {C}_{y , j} ( t )\end{matrix} ] = [ \begin{matrix}Δ {p}_{x , j} ( t ) \\ Δ {p}_{y , j} ( t )\end{matrix} ] - [ \begin{matrix}sgn ( Δ {p}_{x , j} ( t ) ) \cdot {L}_{v} \\ sgn ( Δ {p}_{y , j} ( t ) ) {W}_{v}\end{matrix} ]$$
Where: Lᵥ is the length of the forward vehicle; Wᵥ is the width of the forward vehicle; C_{x,j}(t) is the longitudinal distance between intelligent vehicle and forward vehicle; C_{y,j}(t) is the lateral distance between intelligent vehicle and forward vehicle;
based on the predicted results the longitudinal and lateral distance between the intelligent vehicle and the forward vehicle are modified to realize the reconstruction for safety environment envelope of intelligent vehicle, as shown below:
$$[ \begin{matrix}{C}_{x , j}^{′} ( t ) \\ {C}_{y , j}^{′} ( t )\end{matrix} ] = [ \begin{matrix}{ω}_{x} & 0 \\ 0 & {ω}_{y}\end{matrix} ] \cdot [ \begin{matrix}{C}_{x , j} ( t ) \\ {C}_{y , j} ( t )\end{matrix} ]$$
where parameter ωₓ is the longitudinal correction factor, and represents the variations in scale of longitudinal distance; parameter ω_{y} is the lateral correction factor and represents the variations in scale of lateral distance; the probability value of the result predicted by HMM model is applied to determine the value of ωₓ and ω_{y}.

7. According to the reconstruction method of intelligent vehicle safety environment envelope based on forward vehicle driving behavior described in claim 6, the invention is characterized in that the value range of ωₓ is between 0 and 1, the value range of ω_{y} is between 0 and 1 when the lateral spacing gets smaller, while the lateral distance gets larger, the value range of ω_{y} is greater than 1.
